(19) United States
(12) Patent Application Publication
(10) Pub. No.: US 2010/0240011 A1
(43) Pub. Date: Sep. 23, 2010

(54) Dental Implant Assembly

(75) Inventor: Hsin-Hsiung Liao, Wujie Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIPRECISION CORPORATION, Tucheng City (TW)

(21) Appl. No.: 12/729,460

(22) Filed: Mar. 23, 2010

Related U.S. Application Data
(60) Provisional application No. 61/162,372, filed on Mar. 23, 2009.

(51) Int. Cl. A61C 8/00

(52) U.S. Cl. 433/174

(57) ABSTRACT

A dental implant assembly comprising an implant body, a holder, an inner screw element and a handle is disclosed. The implant body has a first implant end and a second implant end opposite to the first implant end. The second implant end is formed with a first hole having a first thread formed therein. The holder has a first holder end, a second holder end opposite to the first holder end and a second through hole formed from the first holder end to the second holder end. The holder is adapted to connect to the second implant end at the first holder end thereof. The inner screw element has a first screw end and a second screw end opposite to the first screw end. The inner screw element is adapted to penetrate through the second through hole of the holder into the first hole. The first screw end of the inner screw element is formed with a second thread to engage with the first thread of the implant body. The handle has a first handle end and a second handle end opposite to the first handle end. The first handle end is formed with a first handle hole having a configuration corresponding to the second holder end and the second handle end is formed with a second handle hole having a configuration corresponding to the second screw end.

This is a non-provisional application claiming the benefit of priority based on the Provisional Application No. 61/162,372 filed on Mar. 23, 2009.

### CROSS-REFERENCES TO RELATED APPLICATIONS

Not applicable.

### BACKGROUND OF THE INVENTION

1. Field of the Invention

The present invention provides a dental implant assembly. In particular, the present invention provides the dental implant assembly which is much easier to be accessed and used during implantation surgery.

2. Descriptions of the Related Art

In dentistry, artificial teeth, tooth caps or bridges are conventionally used to repair teeth or consolidate intertooth structures. However, this may impose on the healthy adjacent teeth. For example, to provide adequate space for receiving an artificial tooth, a tooth cap or a tooth bridge, the adjacent healthy teeth need to be cut and ground to be smaller to act as a stable support.

With the advancement of science and technologies, dental implantation technology has also been developed. Specifically, a dental implant is directly disposed into an alveolar bone to completely replace the damaged tooth. Since the dental implantation requires no additional devices and support from adjacent teeth, it is less likely to damage adjacent natural teeth and may prevent atrophy of the alveolar bone and the gum, thus maintaining the long-term health and functions of the oral cavity. Some conventional dental implants are made into screws, and are rotatably fastened into the alveolar bone during surgery. The intention is for the dental implant and the alveolar bone to be closely connected in a mechanical way at the very start of the integration to facilitate the growth of osseous tissue on the dental implant.

The dental implantation process proceeds roughly in two stages. In the first stage, a hole is drilled in the alveolar bone and a dental implant is placed therein. The gum is temporarily sutured until the osseointegration period is completed and the newly grown osseous tissue has been closely integrated with the dental implant. During the second stage, the gum is reopened to fix an abutment onto the dental implant. Obviously, to avoid being polluted, the dental implant should be well preserved and be untouchable before it is implanted into the alveolar bone.

As shown in FIG. 1, the conventional dental implant assembly 10 being held onto a frame 17 is illustrated. The conventional dental implant assembly 10 comprises an implant body 11 and a holder 13 which connects with the implant body 11. The holder 13 is removably hangs and secures to the implant body 11. Then, the frame 17 along with the dental implant assembly 10 could be accommodated into a bottle 18 and fastened by a lid 19.

When the surgery is performed, the dentist firstly takes off the dental implant assembly 10 from the frame 17 by grabbing the holder 13. Then, the dentist may equip the holder 13 into a tool and then drive the implant body 11 being drilled into the alveolar bone. However, it is difficult for the dentist to take off the conventional dental implant assembly 10 and equip it onto the tool due to the holder 13 being sized in correspondence with the tool. It is also difficult to orient the dental implant assembly 10 along with the tool into the alveolar bone at the early stage of drilling.

In view of this, it is highly desirable in the art to provide a novel dental implant assembly for facilitating the implantation.

### SUMMARY OF THE INVENTION

One objective of this invention is to provide a dental implant assembly. In comparison with the conventional dental implant assembly, the dental implant assembly of the present invention further has a handle. The handle facilitates the dentist or the user to access or utilize the dental implant assembly.

Another objective of this invention is to provide a dental implant assembly. The dentist can screw the implant body into the alveolar bone at the early stage of drilling by merely operating the handle of the dental implant assembly. Thus, the orientation of screwing the dental implant assembly into the alveolar bone at the early stage could be assured. Furthermore, the handle is also capable of releasing the inner screw element to leave the implant body in the alveolar bone.

To achieve the aforesaid objectives, the dental implant assembly disclosed in this invention comprises an implant body, a holder, an inner screw element and a handle. The implant body has a first implant end and a second implant end opposite to the first implant end. The second implant end is formed with a first hole at the second implant end. The holder has a first holder end and a second holder end opposite to the first holder end. The holder is formed with a second through hole extending from the first holder end to the second holder end, wherein the holder operatively connects to the second implant end at the first holder end thereof. The inner screw element has a first screw end and a second screw end opposite to the first screw end. The inner screw element operatively penetrates through the second through hole into the first hole to connect with the implant body. The handle has a first handle end and a second handle end opposite to the first handle end, wherein the handle is capable of detachably connecting to the holder and the inner screw element at the first handle end and the second handle end thereof respectively.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view showing the conventional dental implant assembly;

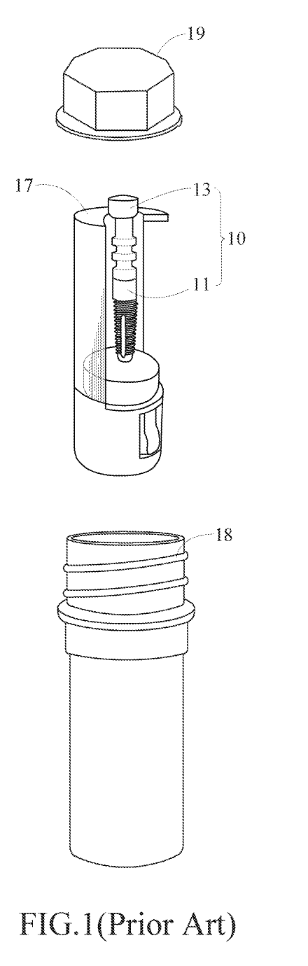

FIG. 2 is a schematic view showing the housing and the dental implant assembly of the present invention;

FIG. 3 is a schematic view showing the dental implant assembly of the present invention;

FIG. 4 is an exploded view showing the dental implant assembly of the present invention;

FIG. 5 is a cross-sectional view along the A-A′ line of FIG. 3;

FIG. 6 is a schematic view showing the dental implant assembly in another using status; and

FIG. 7 is a cross-sectional view along the B-B′ line of FIG. 6.

### DESCRIPTION OF THE PREFERRED EMBODIMENT

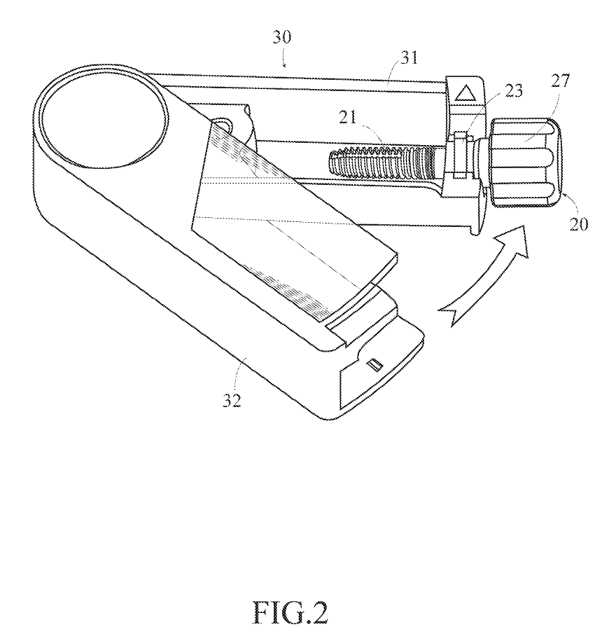

FIG. 2 shows the dental implant assembly 20 of the present invention. The dental implant assembly 20 can be disposed in the housing 30. The housing 30 shown in the figure includes the first body portion 31 and the second body portion 32 which are pivoted with each other. The first body portion 31 has an opening end to receive the dental implant assembly 20. The dentist or the user may open the housing by rotating the second body portion 32 to depart from the first body portion 31 with respect to the pivot end, and take the dental implant assembly 20 out from the housing 30. It is noted that the housing 30 could be in other configurations, e.g. the conventional bottle-type, which is not limited herein.

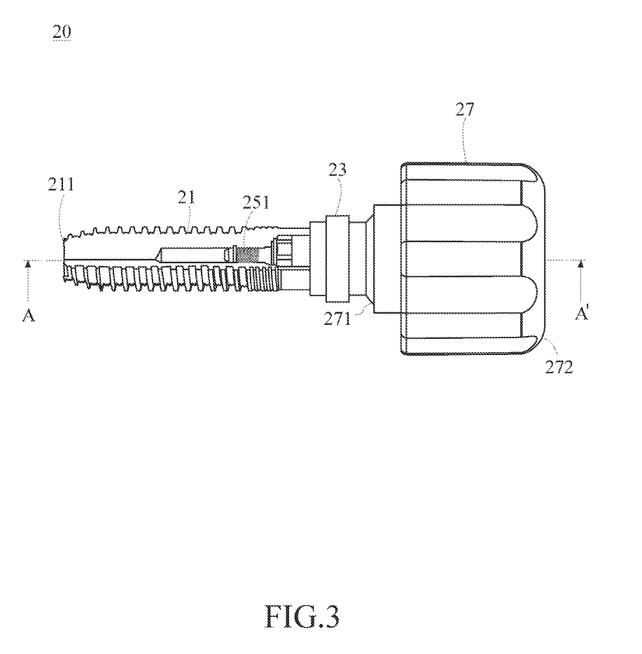

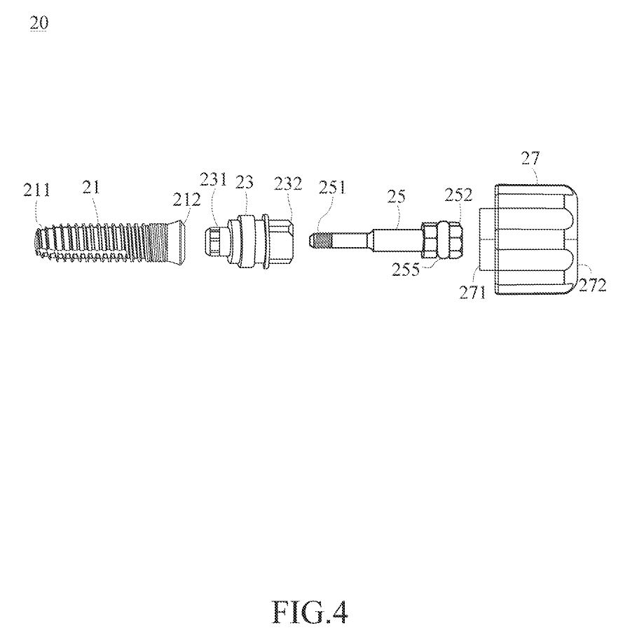

FIG. 3 and FIG. 4 show the dental implant assembly 20 of the present invention. The dental implant assembly 20 comprises an implant body 21, a holder 23, an inner screw element 25 and a handle 27 being assembled with each other. For illustration convenience, the implant body 21 has a first implant end 211 and a second implant end 212 opposite to the first implant end 211. The thread structure for engaging with the alveolar bone is formed on the outer surface of the implant body 21 and extends from the first implant end 211 towards the second implant end 212. Preferably, the thread structure may be varied with the pitch or the thickness for better connection with the alveolar bone. The holder 23 has a first holder end 231 and a second holder end 232 opposite to the first holder end 231. The inner screw element 25 has a first screw end 251 and a second screw end 252 opposite to the first screw end 251. The handle 27 has a first handle end 271 and a second handle end 272 opposite to the first handle end 271.

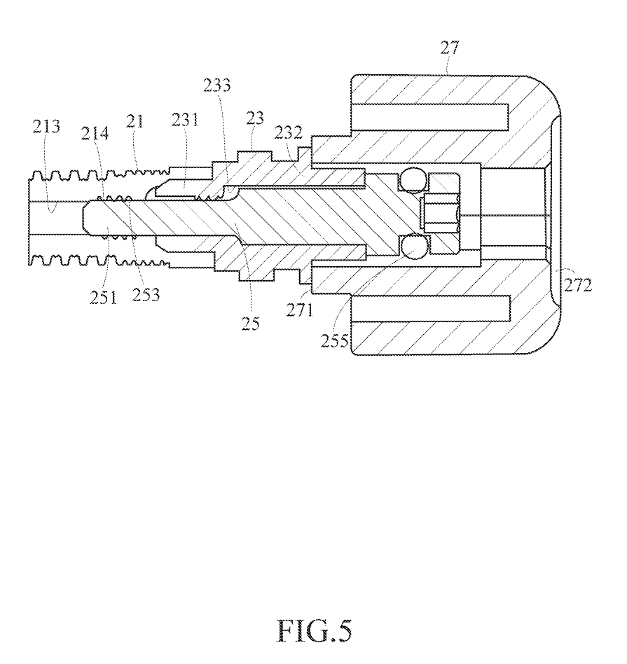

Please also refer to FIG. 5, which is an enlarged cross-sectional view along the A-A′ line of FIG. 3. As shown in FIG. 5, the second implant end 212 of the implant body 21 is formed with a first hole 213. A first thread 214 is formed on the inner surface of the first hole 213. The holder 23 further comprises a second through hole 233 penetrating through the holder 23 from the first holder end 231 to the second holder end 232. The first holder end 231 of the holder 23 is adapted to engage and connect to the second implant end 212 of the implant body 21. For example, the first holder end 231 of the holder 23 includes a male structure having a configuration of polygon or petal, and the first hole 213 includes a female structure which may have a configuration corresponding to the polygon or the petal for receiving the first holder end 231 of the holder 23. Thus, when the holder 23 is driven, the holder 23 would be capable of driving the implant body 21 rotating simultaneously. Furthermore, the second holder end 232 of the holder 23 also includes a male structure which may have a configuration of polygon or petal for connecting with the handle 27.

The inner screw element 25 is adapted to penetrate through the second through hole 233 of the holder 23 and into the first hole 213 of the implant body 21. The first screw end 251 of the inner screw element 25 is formed with a second thread 253 which is adapted to engage with the first thread 214 of the implant body 21. Thus, the inner screw element 25 and the implant body 21 are capable of steadily being secured with each other to operatively vise the holder 23 therebetween.

The handle 27 of the present invention is characterized in that the first handle end 271 has a first handle hole having a configuration corresponding to the second holder end 232 to operatively receive and engage with the second holder end 232, as shown in FIG. 3 and FIG. 5. Thus, the dentist could drive the handle 27, together with driving the holder 23 and the implant body 21 into the alveolar bone at the early stage. At the later stage, the dentist may remove the handle 27 and drive the holder 23 by using an electrical or manual tool.

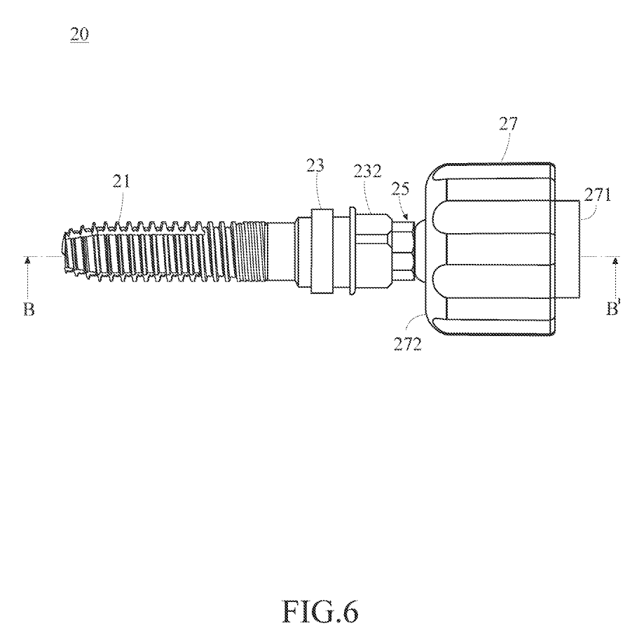

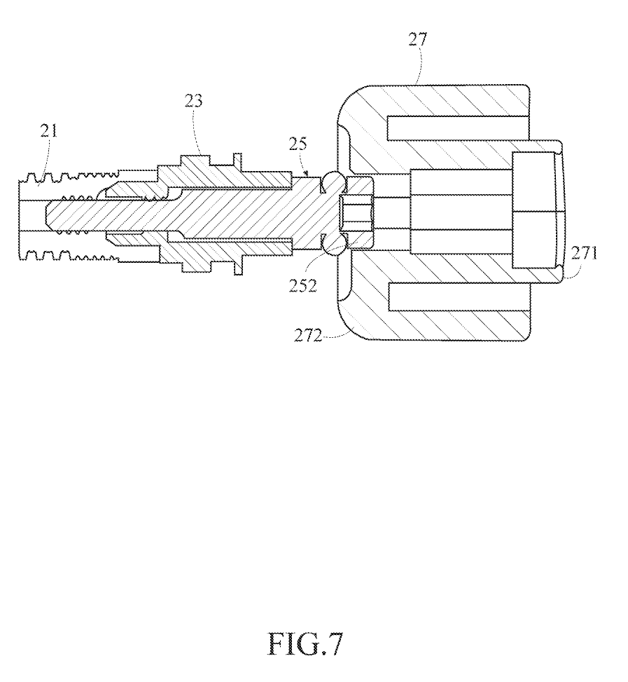

In addition, the second handle end 272 is formed with a second handle hole having a configuration corresponding to the second screw end 252 of the inner screw element 25 as shown in FIG. 6. Also referring to FIG. 7, which is an enlarged cross-sectional view along the B-B′ line of FIG. 6, when the surgery has been completed, the dentist may reverse the handle 27 and assemble the second handle hole of the second handle end 272 with the second screw end 252 of the inner screw element 25. The inner screw element 25 further comprises an O-ring 255 to fit within the second handle hole for enhancing the connecting tightness with the handle 27 when the handle 27 connects to the inner screw element 25 through the second handle end 272 thereof. Thus, the handle 27 merely engages with the second screw end 252 of the inner screw element 25 and is able to release the inner screw element 25 from the implant body 21. After the inner screw element 25 is released, the holder 23 could be subsequently removed.

Given the above, the dental implant assembly of the present invention facilitates the dentist or the user to access. The handle of the dental implant assembly could screw the implant body at the early stage of drilling. Thus, the orientation of screwing the dental implant assembly into the alveolar bone could be assured. The handle is also capable of releasing the inner screw element to leave the implant body in alveolar bone.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A dental implant assembly, comprising:
an implant body having a first implant end and a second implant end opposite to the first implant end, the second implant end being formed with a first hole at the second implant end;
a holder having a first holder end and a second holder end opposite to the first holder end, the holder being formed with a second through hole extending from the first holder end to the second holder end, wherein the holder operatively connects to the second implant end at the first holder end thereof;
an inner screw element having a first screw end and a second screw end opposite to the first screw end, the inner screw element operatively penetrating through the second through hole into the first hole to connect with the implant body; and
a handle having a first handle end and a second handle end opposite to the first handle end, wherein the handle is capable of detachably connecting to the holder and the inner screw element at the first handle end and the second handle end thereof respectively.

2. The dental implant assembly as claimed in claim 1, wherein the first handle end is formed with a first handle hole having a configuration corresponding to the second holder end.

3. The dental implant assembly as claimed in claim 2, wherein the second handle end is formed with a second handle hole having a configuration corresponding to the second screw end.

4. The dental implant assembly as claimed in claim 3, wherein the first hole is formed with a first thread.

5. The dental implant assembly as claimed in claim 4, wherein the first screw end is formed with a second thread being adapted to engage with the first thread of the first hole of the implant body.

6. The dental implant assembly as claimed in claim 5, wherein the inner screw element and the implant body operatively vise the holder therebetween.

7. The dental implant assembly as claimed in claim 3, wherein the implant body is formed with a thread structure on an outer surface thereof.

8. The dental implant assembly as claimed in claim 7, wherein the thread structure extends from the first implant end towards the second implant end.

9. The dental implant assembly as claimed in claim 3, wherein the first holder end includes a male structure having a configuration of polygon or petal.

10. The dental implant assembly as claimed in claim 9, wherein the first hole includes a female structure formed at the second implant end, the female structure having a configuration corresponding to the configuration of the first holder end.

11. The dental implant assembly as claimed in claim 10, wherein the second holder end includes a male structure having a configuration of polygon or petal.

12. The dental implant assembly as claimed in claim 10, wherein the inner screw element further comprises an O-ring to fit within the second handle hole when the handle connects to the inner screw element through the second handle end thereof.
